(19) United States
(12) Patent Application Publication
(10) Pub. No.: US 2014/0305233 A1
(43) Pub. Date: Oct. 16, 2014

(54) GATE RELEASE APPARATUS FOR AUTOMATIC PILL DISPENSER

(71) Applicant: HON HAI PRECISION INDUSTRY CO., LTD., New Taipei (TW)

(72) Inventors: PAO-HENG SHEN, New Taipei (TW); KUO-MING LAI, New Taipei (TW)

(73) Assignee: HON HAI PRECISION INDUSTRY CO., LTD., New Taipei (TW)

(21) Appl. No.: 14/243,043

(22) Filed: Apr. 2, 2014

(30) Foreign Application Priority Data
Apr. 12, 2013 (TW) 102113014

(51) Int. Cl. F16H 19/04

(52) U.S. Cl. CPC F16H 19/04
USPC 74/30

(57) ABSTRACT

A gate release apparatus of an automatic pill dispenser includes a base, a gate, a release assembly, a resisting member, a gear assembly, and a resilient member. The base includes a bottom plate and a ring plate. The ring plate defines an opening. The gate is configured to cover the opening. The gear assembly includes a swing gear. The door includes a rack. The resisting member resists the release assembly in the first position, and the release assembly resists the gear assembly to enable the swing gear to engage with the rack. To disengage from the gear from the gear assembly the release assembly is rotated by the resilient member thereby disengaging the swing from the rack when the resisting member is in a second position.

### FIELD

Embodiments of the present disclosure relate to gate release apparatuses, and particularly to a gate release apparatus of an automatic pill dispenser.

### BACKGROUND

An automatic pill dispenser generally includes a main body defining a pill picking opening and a gate covering the picking opening. However, the gate is mounted to the main body and is always moveable relative to the main body, so that the gate can be opened anytime and by anyone to pick pills out of the main body, allowing access by unauthorized users. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. In the drawings, like reference numerals designate corresponding parts throughout the several views.

FIG. 1 is an exploded, isometric view of one embodiment of a gate release apparatus of an automatic pill dispenser.

FIG. 2 is an isometric view of a release assembly of the gate release apparatus of FIG. 1.

FIG. 3 is an exploded, isometric view of the gate release apparatus of FIG. 1.

FIG. 4 is an exploded, isometric view of a gear assembly of the gate release apparatus of FIG. 3.

FIG. 5 is an assembled, isometric view of the gate release apparatus of FIG. 1.

FIG. 6 is an assembled, isometric view of the gate release apparatus of FIG. 3.

FIG. 7 is similar with FIG. 5, showing a resisting member in a second position from a first position.

FIG. 8 is similar with FIG. 7, but showing the resisting member in the first position from the second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

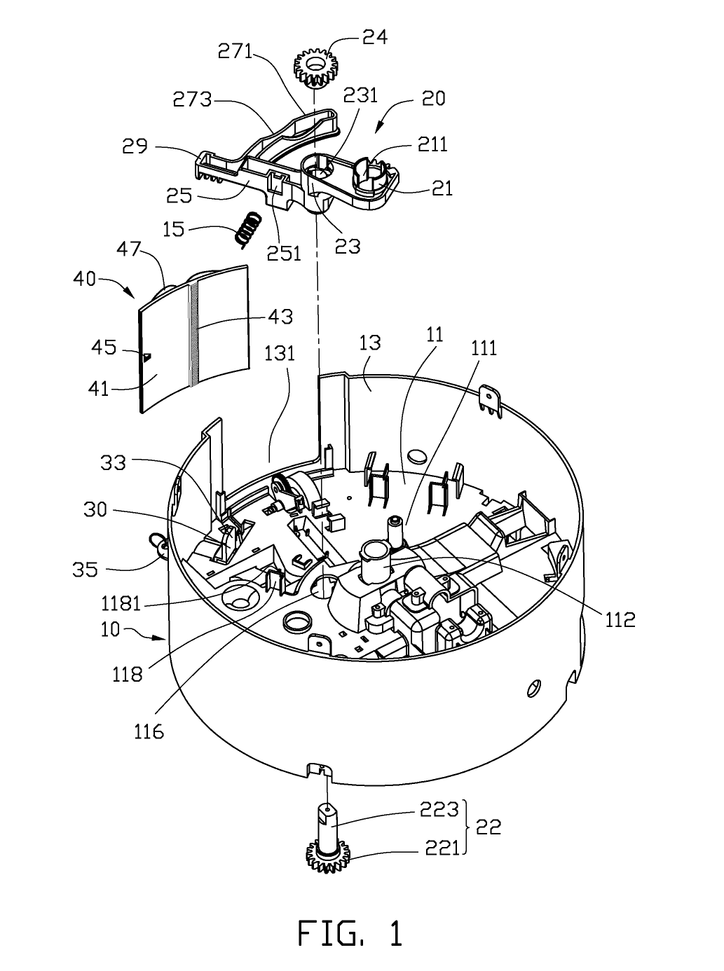

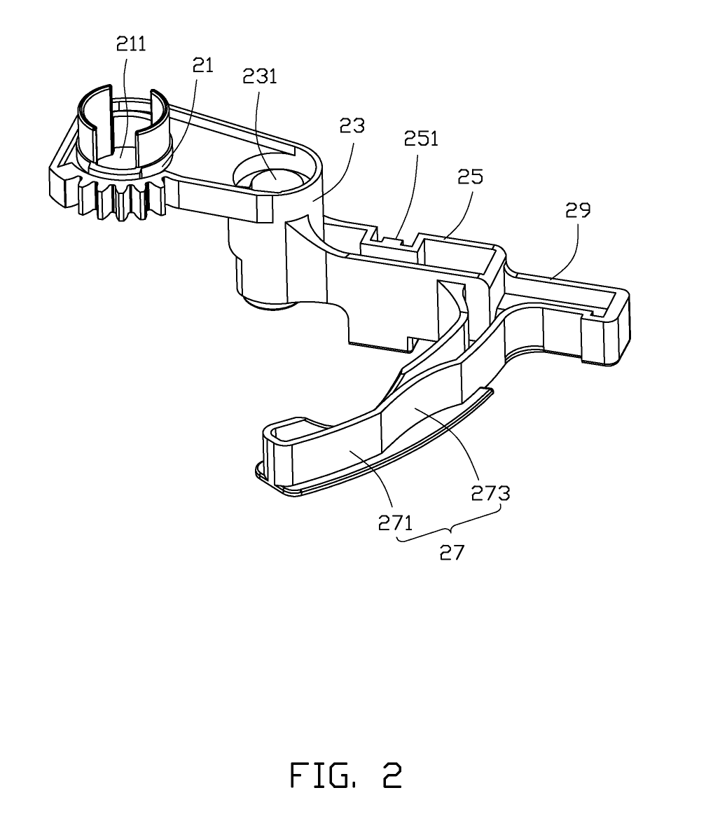

FIGS. 1-3 show one embodiment of a gate release apparatus of an automatic pill dispenser. The gate release apparatus includes a base 10, a release assembly 20, a resisting member 30, a gate 40, a positioning member 50, a gear assembly 60, and a driving member 70. In at least one embodiment, the resisting member 30 is a key module.

The base 10 includes a bottom plate 11 and a ring plate 13 surrounding the bottom plate 11. The bottom plate 11 includes a plate body 111, a pivoting portion 112 extending downwards from the plate body 111, a receiving portion 113 extending upwards from the plate body 111, a holding portion 114 extending upwards from the plate body 111, a positioning post 117, and a securing portion 118. The holding portion 114 defines a holding slot 1141. A slot 115 is defined in each of opposite sides of the holding portion 114. The ring plate 13 defines an opening 131, and the gate 40 is used for covering the opening 131. The bottom plate 11 defines a receiving hole 116. The positioning post 117 defines a positioning hole 1171. The securing portion 118 includes a securing protrusion 1181. A first end of a resilient member 15 is secured to the securing protrusion 1181. In one embodiment, the resilient member 15 is a spring.

The release assembly 20 includes a pivoting portion 21, a rotating portion 23 extending from the pivoting portion 21, a connecting portion 25 extending from the rotating portion 23, an extending arm 27, a limiting portion 29 extending from the connecting portion 25, a connecting member 22, and a locking member 24. The connecting portion 25 defines a connecting slot 251. A second end of the resilient member 15 is received in the connecting slot 251.

The pivoting portion 21 defines a pivoting hole 211. The extending arm 27 includes a recess portion 273 and a resisting portion 271. The recess portion 273 has a curved surface. The rotating portion 23 defines a through hole 231. The connecting member 22 includes a gear portion 221 and a connecting pole 223. The connecting pole 223 can insert through the through hole 231. The locking member 24 is an installation gear to be secured to the connecting pole 223.

The resisting member 30 is secured to the ring plate 13 and includes a key body 31 and a tongue 33 connected to the key body 31. The key body 31 is used for inserting a key 35. The tongue 33 is rotatable by rotating the key 35.

The gate 40 includes a gate body 41, a rack located on an inner surface of the gate body 41, and an operation portion 47 extending from the gate body 41. The gate body 41 defines a positioning opening 45.

The positioning member 50 includes a movable portion 51, a positioning portion 53 extending from the movable portion 51, a movable arm 55 extending from the positioning portion 53, and an installation portion 57 extending from the movable arm 55. The movable portion 51 is pivotably mounted to the bottom plate 11. The installation portion 57 is received in the positioning hole 1171. The positioning portion 53 can be positioned in the positioning opening 45 to position the gate 40.

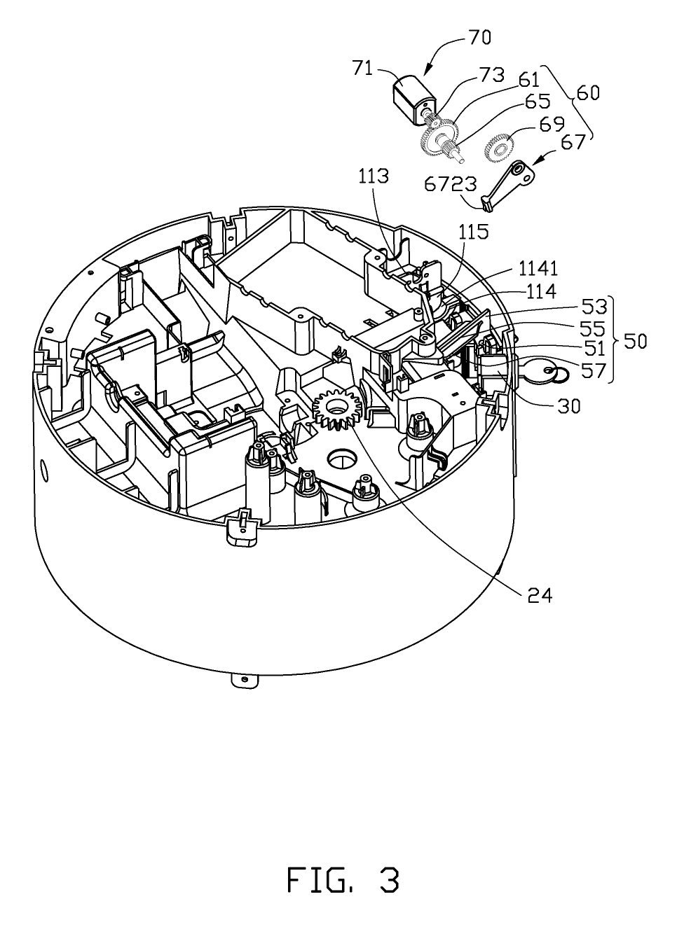

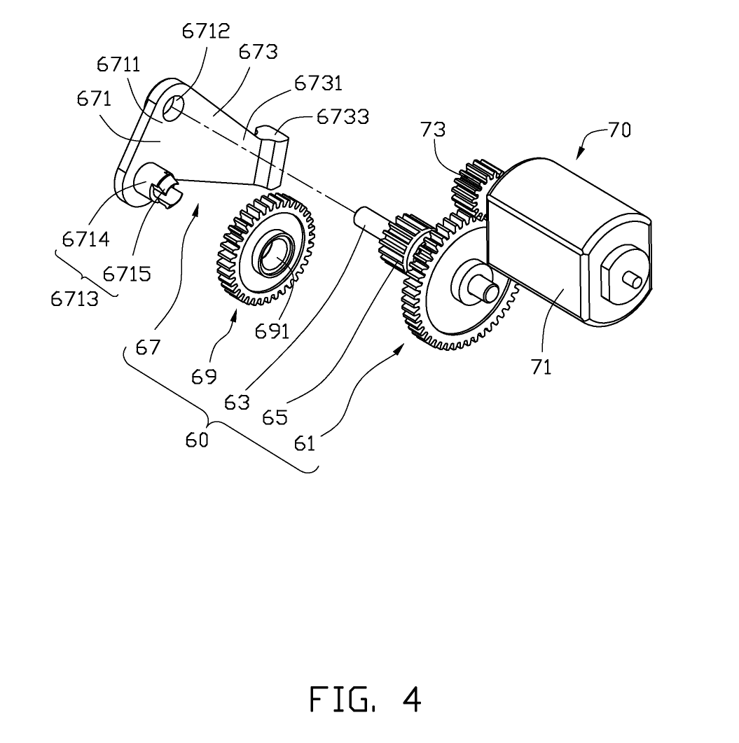

FIG. 3 and FIG. 4 show that the gear assembly 60 includes a shaft 63, a driving gear 61, a driven gear 65, a restricting member 67, and a swing gear 69. The driving gear 61 and the driven gear 65 are secured to the shaft 63. The swing gear 69 is used for meshing with the rack 43. The shaft 63 is pivotably mounted to the bottom plate 11. The restricting member 67 includes a pivoting portion 671 and a restricting arm 673 extending from the pivoting portion 671. The pivoting portion 671 includes a pivoting piece 6711 and a pivoting shaft 6713 extending from the pivoting piece 6711. The pivoting shaft 6713 includes a pivoting body 6714 and two latching portions 6715 extending from the pivoting body 6714. The pivoting piece 6711 defines a mounting hole 6712 for mounting the shaft 63. The restricting arm 673 includes an arm body 6731 and a restricting protrusion 6733 extending from an end of the arm body 6731. The swing gear 69 defines a securing hole 691 corresponding to the pivoting shaft 6713. The two latching portions 6715 are elastically deformed to insert through the pivoting hole 691 and rebound to engage with edges of the pivoting hole 691, to prevent to the swing gear 69 from moving out of the pivoting shaft 6713.

The driving member 70 is a motor and includes a driving body 71 and a main gear 73 connected to the driving body 71. The main gear 73 is meshed with the driving gear 61. The driving body 71 is rotatable to rotate the main gear 73 and the driving gear 61 by a power supply (not shown).

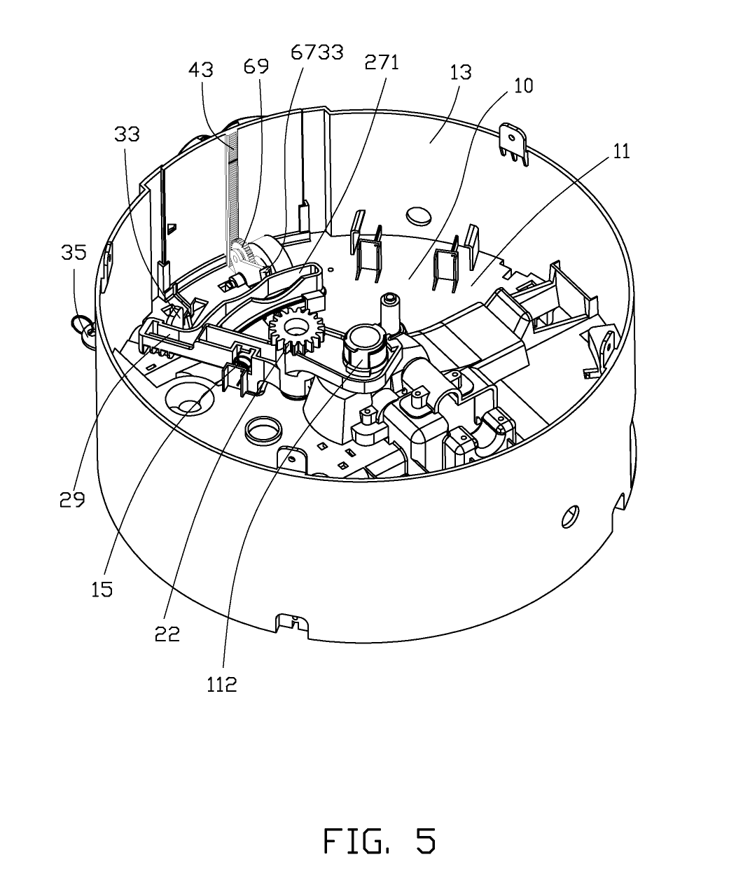

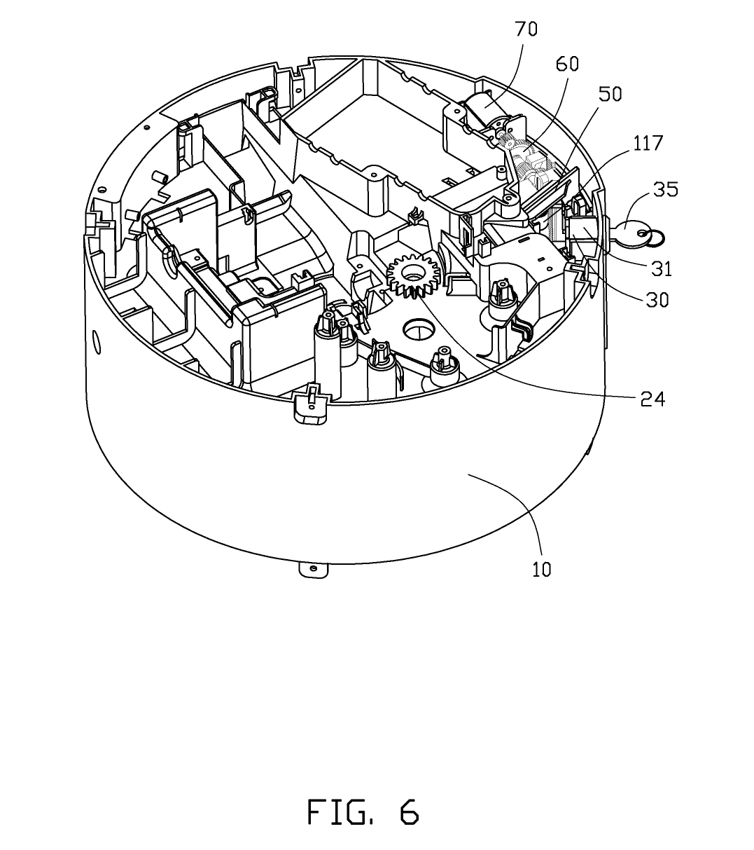

FIG. 5 and FIG. 6 show that in assembly, the pivoting body 112 is inserted into the pivoting hole 211 to pivotably mount the release assembly 20 to the base 10. The release assembly 20 is rotated to align the through hole 231 to the receiving hole 116. The connecting pole 223 is secured to the locking member 24 through the receiving hole 116 and the through hole 231. Thus, the release assembly 20 is movably received in the receiving hole 116.

The picking arm 80 is used for picking pills in a pill box 500 and includes two rotating shafts 83. The pill box 500 defines a picking opening 501 (shown as in FIGS. 5-10). The picking arm 80 defines a through opening 81. The rotating shafts 83 correspond to the third receiving slots 17.

The first end of the resilient member 15 is mounted to the securing protrusion 1181. The second end of the resilient member 15 is received in the connecting slot 251.

The key 35 is rotated to rotate the tongue 33 from a first position to a second position to resist the limiting portion 29. When the tongue 33 is in the second position, the resilient member 15 is compressed, the shaft 63 is placed in the holding slot 1141, the driving gear 61, the restricting member 67, and the swing gear 69 are located in the slot 115, the restricting protrusion 6733 abuts the resisting portion 271, and the swing gear 69 is meshed with the rack 43 and the driven gear 65.

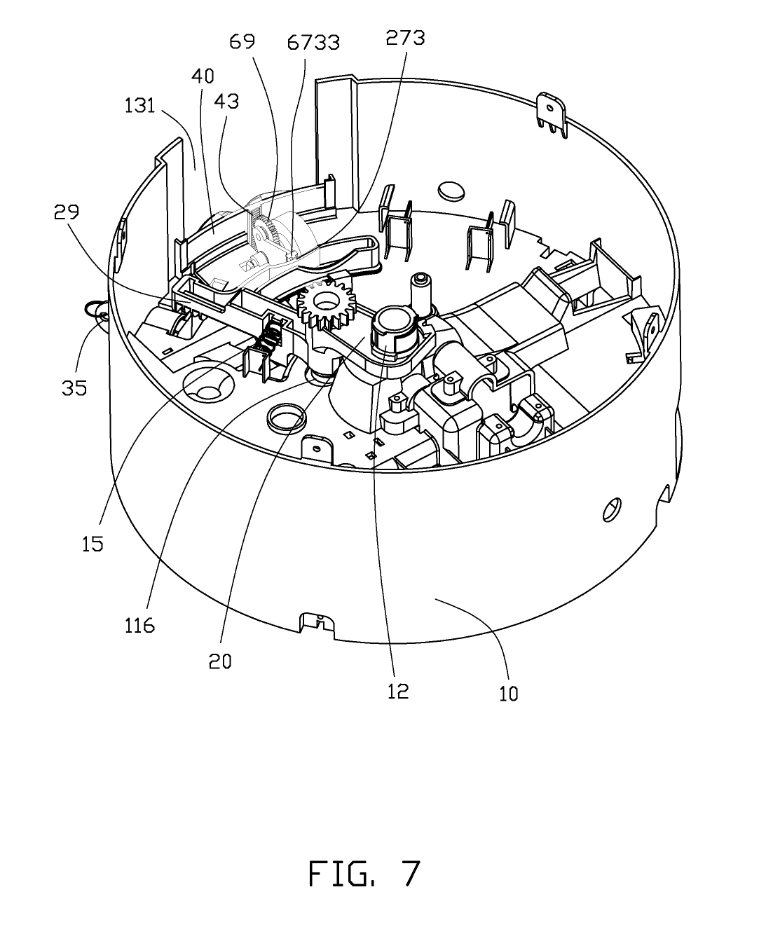

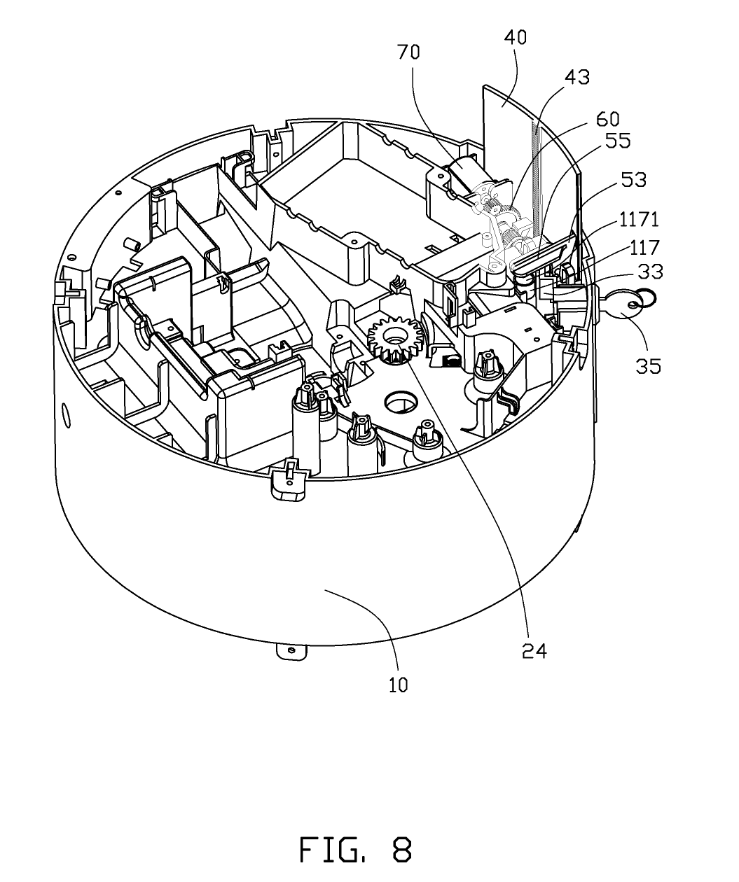

FIG. 7 and FIG. 8 show that, when the driving member 70 is rotated by the power supply, the main gear 73 rotates the driving gear 61. The driving gear 61 rotates the driven gear 65, and then the swing gear 69 is rotated to move the gate 40 upwards to open the gate 40. When the power supply is cut off, the driving member 70 can not be rotated. The key 31 is rotated to rotate the tongue 33 from the second position to the first position. When the tongue 33 is rotated from the second position to the first position, the tongue 33 is disengaged from the limiting portion 29 and moves the movable arm 55 upwards. The resilient member 15 rebounds to rotate the release assembly 20 towards the gate 40, the extending arm 27 is rotated relative the restricting member 67, and the restricting protrusion 6733 moves relative to the release assembly 20 along the resisting portion 271. When the restricting protrusion 6733 moves over the resisting portion 271 and positions in the recess portion 273, the tongue 33 is in the first position. The restricting member 67 is located in a freely rotatable state, and the swing gear 69 disengages from the rack 43 due to the force of gravity, the operation portion 47 is operable to push the gate 40 upwards, and the gate 40 can be stopped when the positioning portion 53 corresponds to the positioning opening 45. Thus, the gate 40 can be pushed up to be opened.

When the key 35 is rotated to rotate the tongue 33 from the first position to the second position, the tongue 33 is disengaged from the movable arm 55, and the positioning member 50 disengages the positioning portion 53 from the positioning opening 45 under the force of gravity. The operation portion 47 is operable to push the gate 40 downwards to cover the opening 131, the resilient member 15 is compressed, and the restricting protrusion 6733 is moved from the recess portion 273 to abut the resisting portion 271 to move the swing gear 69 towards the rack 43 until the swing gear 69 is meshed with the rack 43. The gate 40 can be moved up and down by the driving member 70 through the power supply.

It is to be understood, however, that even though numerous characteristics and advantages have been set forth in the foregoing description of embodiments, together with details of the structures and functions of the embodiments, the disclosure is illustrative only and changes may be made in detail, including in the matters of shape, size, and the arrangement of parts within the principles of the disclosure. The embodiments are illustrative examples, and are not intended to limit the scope of the following claims.

What is claimed is:

1. A gate release apparatus of an automatic pill dispenser, the apparatus comprising:
a base comprising a bottom plate and a ring plate connected to the bottom plate; the ring plate defines an opening;
a gate with a rack, movably mounted to the ring plate and being configured for covering the opening;
a release assembly pivotably mounted to the bottom plate;
a resisting member movably mounted in the base;
a gear assembly comprising a swing gear; and
a resilient member secured between the base and the release assembly;
wherein the resisting member is movable relative to the base between a first position and a second position; when the resisting member is in the first position, the resisting member blocks the release assembly, the release assembly abuts the gear assembly to mesh the swing gear with the rack, the resilient member is elastically deformed, and the gate is prevented from being moved; and when the resisting member is in the second position, the resisting member releases the resilient member, the resilient member moves the release assembly relative to the gear assembly to release the gear assembly, the swing gear is disengaged from the rack, and the gate is movable relative to the base.

2. The gate release apparatus of claim 1, wherein the gear assembly further comprises a shaft, a driven gear secured to the shaft, and a restricting member secured to the shaft; the swing gear is pivotably mounted to the restricting member and meshed with the driven gear;
and when the resisting member is in the first position, the release assembly abuts the restricting member.

3. The gate release apparatus of claim 2, wherein the restricting member comprises a pivoting portion and a restricting arm extending from the pivoting portion; the pivoting portion is secured to the shaft; and the swing gear is pivotably mounted to the pivoting portion.

4. The gate release apparatus of claim 3, wherein the pivoting portion comprises a pivoting piece and a pivoting shaft extending from the pivoting piece; the pivoting piece defines a mounting hole to mount the shaft; and the swing gear defines a pivoting hole to pivotably receive the pivoting shaft.

5. The gate release apparatus of claim 4, wherein the pivoting shaft comprises a pivoting body and a latching portion extending from the pivoting body, the pivoting body is pivotably received in the pivoting hole, and the latching portion is engaged with edges of the pivoting hole.

6. The gate release apparatus of claim 2, wherein the release assembly comprises an extending arm, which comprises a recess portion and a resisting portion; the resisting arm comprise an arm body and a restricting protrusion; the restricting protrusion abuts the resisting portion when the resisting member is in the first position; and the restricting protrusion is located in the recess portion when the resisting member is in the second position.

7. The gate release apparatus of claim 6, wherein the recess portion has a curved surface.

8. The gate release apparatus of claim 6, wherein the release assembly further comprises a movable portion, a connecting portion extending from the movable portion, and a limiting portion extending from the connecting portion; the extending arm extends from the connecting portion; when the resisting member is in the first position, the resisting member blocks the limiting portion; and when the resisting member is in the second position, the resisting member disengages from the limiting portion.

9. The gate release apparatus of claim 2, further comprising a driving assembly, wherein the gear assembly further comprises a driving gear secured to the shaft; the driving assembly comprises a main gear meshed with the driving gear.

10. The gate release apparatus of claim 2, further comprising a positioning member pivotably mounted to the gate, wherein the positioning member comprises a rotating portion rotatably mounted to the bottom plate; a positioning portion extending from the rotating portion, and a movable arm extending from the positioning portion; the gate defines a positioning opening; when the resisting member rotates from the first position to the second position, the resisting member moves the movable arm to rotate the positioning member towards the gate; and when the resisting member is in the second position, the gate is movable to position the positioning portion in the positioning opening, causing the gate to stop in a preset position.

11. A gate release apparatus of an automatic pill dispenser, the apparatus comprising:
a base comprising a bottom plate and a ring plate connected to the bottom plate; the ring plate defines an opening;
a gate movably mounted to the ring plate and being configured for covering the opening;
a gear assembly comprising a swing gear; and
a driving member;
wherein the gate comprises a gate body and a rack located on the gate body; the swing gear is meshed with the rack; and the driving member is rotatable to rotate the swing gear and thereby cause the gate to move relative to the base to open the opening.

12. The gate release apparatus of claim 11, further comprising a release assembly pivotably mounted to the bottom plate and a resisting member movably mounted in the base, wherein the resisting member is movable relative to the base between a first position and a second position; when the resisting member is in the first position, the resisting member blocks the release assembly, the release assembly abuts the gear assembly to mesh the swing gear with the rack, and the gate is prevented from being moved; and when the resisting member is in the second position, the resisting member releases the swing gear from the rack, and the gate is movable relative to the base.

13. The gate release apparatus of claim 12, further comprising a resilient member mounted between the bottom plate and the release assembly, wherein when the resisting member is in the first position, the resilient member is elastically deformed; and when the resisting member is in the second position, the resisting member releases the resilient member, the resilient member moves the release assembly relative to the gear assembly to release the gear assembly.

14. The gate release apparatus of claim 11, wherein the gear assembly further comprises a shaft, a driven gear secured to the shaft, and a restricting member secured to the shaft; the swing gear is pivotably mounted to the restricting member and meshed with the driven gear; and when the resisting member is in the first position, the release assembly abuts the restricting member.

15. The gate release apparatus of claim 14, wherein the restricting member comprises a pivoting portion and a restricting arm extending from the pivoting portion; the pivoting portion is secured to the shaft; and the swing gear is pivotably mounted to the pivoting portion.

16. The gate release apparatus of claim 15, wherein the pivoting portion comprises a pivoting piece and a pivoting shaft extending from the pivoting piece; the pivoting piece defines a mounting hole to mount the shaft; and the swing gear defines a pivoting hole to pivotably receive the pivoting shaft.

17. The gate release apparatus of claim 12, wherein the release assembly comprises an extending arm, which comprises a recess portion and a resisting portion; the resisting arm comprise an arm body and a restricting protrusion; the restricting protrusion abuts the resisting portion when the resisting member is in the first position; and the restricting protrusion is located in the recess portion when the resisting member is in the second position.

18. The gate release apparatus of claim 17, wherein the recess portion has a curved surface.

19. The gate release apparatus of claim 17, wherein the release assembly further comprises a movable portion, a connecting portion extending from the movable portion, and a limiting portion extending from the connecting portion; the extending arm extends from the connecting portion; when the resisting member is in the first position, the resisting member blocks the limiting portion; and when the resisting member is in the second position, the resisting member disengages from the limiting portion.

20. The gate release apparatus of claim 12, further comprising a positioning member pivotably mounted to the gate, wherein the positioning member comprises a rotating portion rotatably mounted to the bottom plate; a positioning portion extending from the rotating portion, and a movable arm extending from the positioning portion; the gate defines a positioning opening; when the resisting member rotates from the first position to the second position, the resisting member moves the movable arm to rotate the positioning member towards the gate; and when the resisting member is in the second position, the gate is movable to position the positioning portion in the positioning opening, causing the gate to stop in a preset position.
